(19) United States
(12) Patent Application Publication
(10) Pub. No.: US 2015/0074129 A1
(43) Pub. Date: Mar. 12, 2015

(54) AUGMENTING MEDIA PRESENTATION DESCRIPTION AND INDEX FOR METADATA IN A NETWORK ENVIRONMENT

(71) Applicant: CISCO TECHNOLOGY, INC., San Jose, CA (US)

(72) Inventors: Eric Colin Friedrich, Somerville, MA (US); Matthew Francis Caulfield, Clinton, MA (US); Carol Etta Iturralde, Framingham, MA (US); Mahesh Vittal Viveganandhan, Cupertino, CA (US); Scott C. Labrozzi, Cary, NC (US)

(73) Assignee: CISCO TECHNOLOGY, INC., San Jose, CA (US)

(21) Appl. No.: 14/025,669

(22) Filed: Sep. 12, 2013

(51) Int. Cl. G06F 17/30

(52) U.S. Cl. CPC G06F 17/30289
USPC 707/756

(57) ABSTRACT

A method is provided in one example and includes receiving common format media including timed metadata associated with a timed metadata event. The method further includes extracting timed metadata information from the timed metadata, and generating a manifest corresponding to the common format media including the timed metadata information. The timed metadata information includes an indicator of a start time and an indicator of a duration of the timed metadata event. The method further includes generating a common format asset including the manifest.

### TECHNICAL FIELD

This disclosure relates in general to the field of communications and, more particularly, to augmenting a media presentation description and index for metadata in a network environment.

### BACKGROUND

An MPEG-2 Transport Stream (MPEG2-TS) as developed by the Moving Picture Expert Group (MPEG) typically contains video, audio, and metadata tracks that are transmitted together in a multiplexed format. When the MPEG2-TS formatted data is converted from the MPEG2-TS format to an adaptive bitrate (ABR) streaming format, the metadata tracks are converted into a format supported by an ABR client. Adaptive bitrate streaming is a technique in which the quality of a media stream is adjusted when the media stream is delivered to a client in order to conform to a desired bitrate. The conversion of metadata tracks should occur for all types of timed metadata including, but not limited, to closed captions, subtitles, application specific metadata, and ad-insertion markers. Existing ABR pipelines convert the source asset into target specific formats and store the result on an origin server until requested by the client. This procedure produces multiple versions of audio, video and metadata tracks for each of the different formats required by each ABR client.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for augmenting a media presentation description and index for metadata in a network environment in accordance with one embodiment of the present disclosure;

FIG. 2 illustrates an embodiment of a transport stream including video, audio, and timed metadata associated with a media presentation;

FIG. 3 illustrates an embodiment of a media presentation description (MPD) data format;

FIG. 4 is a simplified diagram of an embodiment of a common format asset as generated by the common format publisher of the encapsulator of FIG. 1;

FIG. 5 illustrates a simplified block diagram of an embodiment of the encapsulator of FIG. 1;

FIG. 6 illustrates a simplified block diagram of an embodiment of the origin server and the storage device of FIG. 1;

FIG. 7 is a simplified flowchart illustrating one potential operation of the encapsulator of FIG. 1; and

FIG. 8 is a simplified flowchart illustrating one potential operation of the origin server.

### DETAILED DESCRIPTION OF EXAMPLE EMBODIMENTS

### Overview

A method is provided in one example and receiving common format media including timed metadata associated with a timed metadata event. The method further includes extracting timed metadata information from the timed metadata, and generating a manifest corresponding to the common format media including the timed metadata information. The timed metadata information includes an indicator of a start time and an indicator of a duration of the timed metadata event. The method further includes generating a common format asset including the manifest. In more particular embodiments, the method further includes sending the common format asset to at least one server. In more particular embodiments, the method further includes receiving a request for the timed metadata from a particular client device, extracting the timed metadata information from the manifest, and generating the timed metadata in a target format suitable for the particular client device using the timed metadata information. In a particular embodiment, the method further includes sending a response message including the timed metadata in the target format to the particular client device.

### EXAMPLE EMBODIMENTS

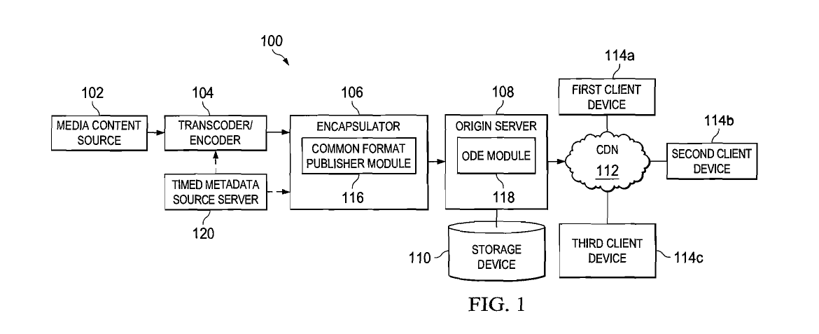

Referring now to FIG. 1, FIG. 1 is a simplified block diagram of a communication system 100 for augmenting a media presentation description and index for metadata in a network environment in accordance with one embodiment of the present disclosure. FIG. 1 includes a media content source 102, a transcoder/encoder 104, an encapsulator 106, an origin server 108, a storage device 110, a content delivery network (CDN) 112, a first client device 114a, a second client device 114b, and a third client device 114c. Encapsulator 106 includes a common format publisher module 116, and origin server 108 includes an On-Demand Encapsulation (ODE) module 118.

In the particular illustrated embodiment, media content source 102 is in communication with transcoder/encoder 104, and transcoder/encoder 104 is in further communication with encapsulator 106. Encapsulator 106 is in further communication with origin server 108, and origin server 108 is in further communication with storage device 112. Storage device 112 may include one or more of local storage, network storage, or any other suitable storage device. Origin server 108 is further in communication with first client device 114a, second client device 114b, and third client device 114c via CDN 112. In one or more embodiments, first client device 114a, second client device 114b, and third client device 114c are adaptive bit rate (ABR) end client devices. First client device 114a, second client device 114b, and third client device 114c may include one or more of a set-top box, a television, a computer, a mobile computing device, or any other suitable client device. Communication system 100 may further include a timed metadata source server 120 in communication with one or more of transcoder/encoder 104 and encapsulator 106.

A fundamental issue in content delivery is the need to serve a wide variety of types of end-client devices. In the context of adaptive bit rate (ABR) video, these various end-client types each typically require specific metadata and video and audio formats. Examples of prevalent ABR client types include Microsoft HTTP Smooth Streaming (HSS), Apple HTTP Live Streaming (HLS), Adobe HTTP Dynamic Streaming (HDS), and MPEG Dynamic Adaptive Streaming over HTTP (DASH). A server which handles requests from a heterogeneous pool of ABR clients should typically store its media content including video, audio, and metadata in a form which can be easily translated to a target format that is suitable and recognizable by a particular client device. In a simple implementation, such a server could store a separate copy of a piece of media content for each end client device type. However, this approach negatively impacts storage and bandwidth usage. In a content distribution network (CDN), multiple formats of the same piece of content will be treated independently, further exacerbating the problem. CDN 112 is a network of intermediate nodes that function to cache content in a hierarchy of locations to decrease the load on origin server 108 and to improve the quality of experience for the users using client devices 114a-114c to receive media content.

On-demand encapsulation (ODE) addresses the storage and bandwidth issues presented by the simple implementation. With ODE, a single representation of each piece of common format media is stored and cached by the server. Upon receiving a client request for the media content, the server re-encapsulates the common format media representation into an end-client-specific format. ODE provides a tradeoff between storage and computation requirements. While storing a common format media representation incurs lower storage overhead, re-encapsulating that representation on-demand is more usually expensive computationally than storing each end-client representation individually.

A common format asset should be chosen to meet the needs of all end-client ABR format types. The common format asset is a collection of items including the original common format media. The common format asset may also contain index files, both media indexes (i.e. audio/video), metadata index files, and a Media Presentation Description (MPD). The MPD is a manifest or file containing information about the media content such as one or more formats of segments of audio or video data. The common format asset and its associated metadata should be capable of being easily translated into an end-client format. An example of a common format asset that meets this requirement is Adaptive Transport Stream (ATS) with Dynamic Adaptive Streaming over HTTP (DASH) metadata. An Adaptive Transport Stream is an ABR conditioned annotated MPEG-2 Transport Stream (MPEG2-TS) stream with in-band metadata for signaling ABR fragment and segment boundaries. Dynamic Adaptive Streaming over HTTP (DASH) is a standard for describing ABR content. ISO Base Media File Format (ISO-BMFF) with DASH metadata (DASH/ISO-BMFF) is another example of a common format asset that may be used.

A typical ABR content workflow for on-demand encapsulation may be understood as a pipeline of functional blocks strung together for the purpose of delivering ABR content to end-clients. Raw/compressed media content arrives into the system and an encoding/transcoding stage converts the content into multiple ABR-conditioned compressed versions. This is the common format media. An encapsulation stage further processes the common format media to produce a common format asset, which contains the sourced common format media, various indexes of this media content and a media presentation description. A recording stage accepts the common format asset and writes it to storage. An origination stage reads the common format asset and performs re-encapsulation of the media into a target format when a request is received from a particular end client device. The origination stage serves media content in the target format based upon a request received from a client device. The target format of the media content may be based upon client type. In particular examples, a CDN may cache content in a hierarchy of locations to decrease the load on the origination stage and to improve the quality of experience for the users in the client stage. Finally, in a client stage, a client device receives the requested media content decodes and presents the content to the end-user.

A common format media stream such as an Adaptive Transport Stream typically contains multiplexed video, audio, and timed metadata. When the content is converted to an adaptive bitrate (ABR) streaming format, the metadata is converted into a target format supported by the particular ABR client such as client device 116. This conversion should occur for all types of timed metadata including but not limited to captions, subtitles, application-specific metadata, and ad-insertion markers. For example, a Microsoft Smooth client requires caption data formatted in SMPTE Timed Text Markup Language (TTML).

Existing non-on-demand ABR pipelines convert the source asset into target specific formats and store the result on an origin server until requested by the client. This typically includes multiple versions of audio, video and metadata tracks for the different ABR formats. However, with on-demand encapsulation technology, origin servers no longer need to store multiple versions of the same ABR asset. Instead, by storing the source asset data using a common format asset, such as using the common intermediate file (CIF) format, ODE module 118 can create a specific ABR segment needed, in the correct target format, in response to a client's request.

Media content source 102 is in communication with transcoder/encoder 104 and is configured to provide media content to transcoder/encoder 104. In one or more embodiments, the source media may include video and/or audio data. In at least one embodiment, the media content is provided to transcoder/encoder 104 in a raw format. In still other embodiments, the media content may first be encoded such that the raw format media content is converted into a compressed format before being provided to transcoder/encoder 104. In still other embodiments, encoding of raw format media content may be performed by transcoder/encoder 104. In a particular embodiment, the media content is encoded in an MPEG2-TS format.

Timed metadata source server 120 may be configured to provide timed metadata to transcoder/encoder 104. In still other embodiments, the media content source 102 may provide the timed metadata as well as the source media. The timed metadata may include, for example, advertising insertion metadata indicating particular advertising content such as video, audio, or textual advertising content that should be inserted within the source media content at a particular time. In a particular embodiment, the ad-insertion metadata includes STCE35 digital program insertion signal as developed by the Society of Cable Telecommunications Engineers (STCE). STCE35 packets are 188 bytes in size and have an STCE35 packet identifier (PID) that is described in the stream. STCE35 packets may contain a time at which an advertisement start or ends, whether the advertisement is beginning or ending, and other information such as an identifier to identify the advertisement. In still other embodiments, the timed metadata may include closed caption data, subtitle data, or any other application specific metadata. In at least one embodiment, timed metadata source service may be configured to make decisions or determinations regarding when particular timed metadata is to be inserted within the media content.

Transcoder/encoder 104 is configured to transcode the source media into one or more transcoded versions of the media content having bitrate, quality or other parameters that differ from that of the original media content. For example, in particular embodiments, transcoder/encoder 104 transcodes the source media into one or more lower quality versions of the original media content in order for the media content to be more suitable for streaming. Transcoder/encoder 104 is further configured to pass the transcoded media content and timed metadata to encapsulator 106. In still other embodiments, encapsulator 106 may be configured to receive the timed metadata directly from timed metadata source server 120.

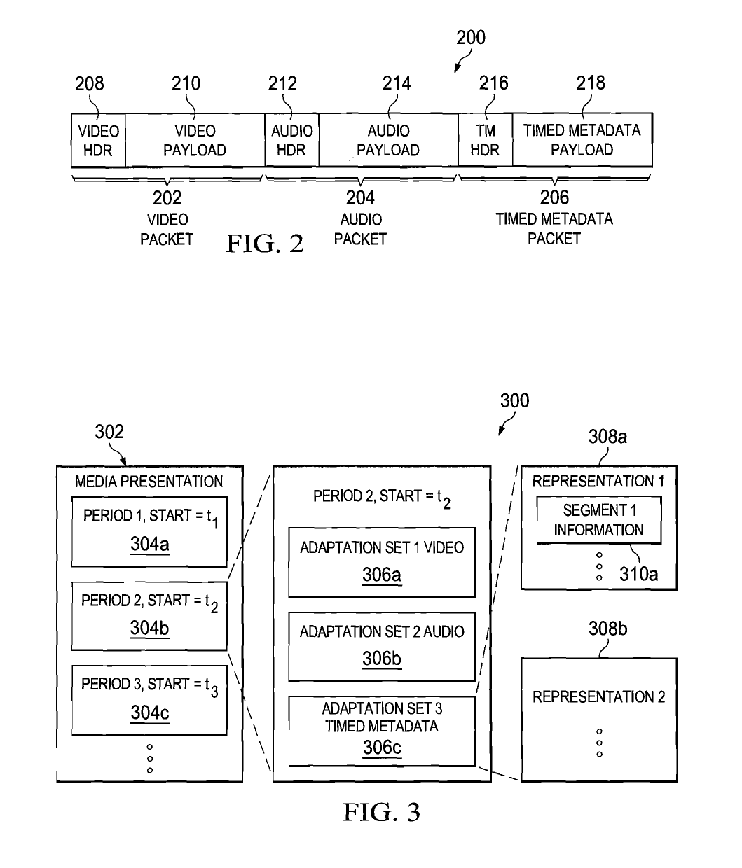

Referring now to FIG. 2, FIG. 2 illustrates an embodiment of a transport stream 200 including video, audio, and timed metadata associated with a media presentation. In a particular embodiment, transport stream 200 is in an MPEG-TS format. The transport stream 200 includes a video packet 200, an audio packet 204, and a timed metadata packet 206. Video packet 202 includes a video header portion 208 and a video payload portion 210. In one or more embodiments, video header portion 208 includes a packet identifier (PID) indicating the particular video stream to which video packet 200 belongs. In one or more embodiments, each video packet associated with a video stream of a media presentation is designated with the same PID. Video payload portion 210 includes the video data associated with the media presentation such as encoded video frames of the media presentation. Similarly, audio packet 204 includes an audio header portion 212 and an audio payload portion 214. Audio header portion 212 may include a PID identifying audio packet 204 as belonging to a particular audio stream of the media presentation. Audio header portion 212 includes audio data associated with the media presentation. In various embodiments, the transport stream 200 may include multiple audio streams. Timed metadata packet 206 includes a timed metadata header portion 216 and a timed metadata payload portion 218. Timed metadata header portion may include a PID identifying timed metadata packet 206 as belong to a timed metadata stream associated with the media presentation. Timed metadata payload portion 218 includes timed metadata associated with the media presentation. In a particular embodiment, timed metadata payload portion 208 may include ad-insertion metadata such as STCE-35 data. In other particular embodiments, timed metadata payload portion 218 may include closed-captioning or other timed metadata. It should be understood that in various embodiments, the PIDs associated with each of video header portion 208, audio header portion 212, and timed metadata portion 216 do not have the same PID value. It should also be understood that transport stream 200 is illustrated as having a single video packet 202, a single audio packet 204, and a single timed metadata packet 206 interleaved together for simplicity of illustration. However, in other embodiments transport stream 200 may include any number of video packets, audio packets, and timed metadata packets.

Referring again to FIG. 1, in at least one embodiment encapsulator 106 is configured to receive the transcoded source media content and timed metadata and provide the transcoded source media content and timed metadata to common format publisher module 116. Common format publisher module 116 is configured to generate a media content data in a common format and a manifest or index data corresponding to the media content data. The media content data includes the video, audio, and/or timed metadata of the media content and timed metadata received from transcoder/encoder 104 published in a common format suitable for later encapsulation into a target ABR format appropriate for delivery to a particular client device 114a-114c. In one or more embodiments, the common format media content data is an ISO-BMFF file. The manifest or index data indicates the location of particular segments or fragments of video, audio, and/or timed metadata within the media content data file. In a particular embodiment, the manifest or index data is a DASH media presentation description (MPD).

Encapsulator 106 then sends the common format media content data and index data to origin server 108. In response, origin server 108 stores the common format media content data and index data corresponding to the common format media content data within storage device 110. Although the embodiment illustrated in FIG. 1 shows a single storage device 110, it should be understood that in other embodiments one or more storage devices may be used.

At a later time, one or more of client devices 114a-114c may request the timed metadata from origin server 108 via CDN 114 and CDN 114 may relay the request to origin server 108. In some embodiments, the request may also include a request for the media content such as audio or video within the media content. ODE module 118 is configured to retrieve the common format media content data file and index data from storage device 110 and determine the portions of the video, audio, and/or timed metadata needed to service the request. ODE module 110 then uses the index data to extract only the portions of the video, audio, and timed metadata within the common format file needed for the duration of time corresponding to the request, converts the video, audio, and/or timed metadata into a target format supported by the particular client device 114a-114c, and encapsulates and sends the video, audio and/or timed metadata in the target format to the particular client device 114a-114c.

Existing ways of indexing or generating a manifest for media content, such as DASH MPD, provides for a manner of describing media segments occurring during a timeline. The DASH Specification provides examples for audio and video media segments. However, the DASH specification does not define how to handle timed metadata associated with a media presentation. For example, a manner of specifying the inclusion of subtitling, captions, and ad-insertion are not described within the scope of the DASH specification. Although the DASH MPD may indicate when subtitles or captions are present, it does not describe how such metadata should be including within the MPD or how to communicate such metadata to client devices.

Various embodiments described herein provide for a procedure for describing sparse tracks or other timed metadata within a common format index by including information indicative of a time or location of timed metadata within common format media content data as well as other attributes of the timed metadata within the common format index. In one or more embodiments, the attributes of the content of the timed metadata included in the common format index may include a timeline describing start times and durations of the timed metadata content within the common format media content data. In a particular embodiment, the common format index is a DASH MPD and the timed metadata index information is included within an Adaptation Set of the DASH MPD as will be further described herein.

Upon receiving a request from a particular client device 114a-114c, ODE module 118 may create sparse tracks or a manifest/index for a target ABR format that contains information indicative of where timed metadata occurs within the media content. For example, a manifest may indicate that is an advertisement at a specific time within the playback of the content. Accordingly, ODE module 118 requires a mechanism to inform a particular client device 114a-114c about upcoming timed metadata. In a particular example, the timed metadata may include information regarding an upcoming advertisement in which the information is included within an STCE-35 packet. An STCE-35 packet is an MPEG2-TS packets that carries metadata regarding when an advertisement splice point occurs within a media presentation and whether it is a splice out of from the normal presentation to an advertisement or splice back in from the advertisement to the normal presentation. The STCE-35 packets may carry a time field, a type field indicative of whether it is a splice in or splice out, as well as other metadata.

Particular embodiments describe a procedure to include timed metadata, such as STCE35 data, into the common format index, such as a DASH MPD, prior to receiving a request for the data from one or more of client devices 114a-114c. Upon receiving a request for metadata, ODE module 118 does not need to retrieve the entire media content from storage device 110 and parse these packets from the entire media content. Instead, ODE module 118 can retrieve the common format index and obtain information it needs to directly create the manifest/index or sparse track in the desired format using the information contained in the common format index file such as a time at which the splice occurs, whether it is a splice in or splice out and what other metadata that may be present in the original STCE35 message.

FIG. 3 illustrates an embodiment of a media presentation description (MPD) data format 300. MPD data format 300 illustrates a hierarchical data format for the inclusion of video, audio, and timed metadata associated with a media presentation. In a particular embodiment, the MPD document is a common format index file. A media presentation description (MPD) document 302 includes a sequence of periods in time that comprise the media presentation. The particular example illustrated in FIG. 3 includes a first period (Period 1) 304a having a start time t₁ within a media presentation timeline, a second period (Period 2) 304b having a start time t₂ within the media presentation timeline, and a third period (Period 3) 304c having a start time t₃ within the media presentation timeline. Each period may include one or more Adaptation Sets. Each Adaptation Set is a data structure that may include one or more media content components such as video components, audio components, or timed metadata components. For example, in a particular embodiment there may be one Adaptation Set for the main video component, one Adaptation Set for the main audio component, and one Adaptation Set for the timed metadata component of a media presentation. In the particular embodiment illustrated in FIG. 3, second period 304b includes a first Adaptation Set (Adaptation Set 1) 306a including video content data, a second Adaptation Set (Adaptation Set 2) 306b including audio content data, and a third Adaptation Set (Adaptation Set 3) 306c including timed metadata.

Each Adaptation Set may include one or more Representations. A Representation describes a deliverable encoded version of one or more media content components in which a single Representation within an Adaptation Set is sufficient to render the contained media content components. In particular embodiments, an ABR client may switch between Representations within an Adaptation Set in order to adapt to network conditions and other factors. In the particular embodiment illustrated in FIG. 3, third Adaptation Set (Adaptation Set 3) 306c includes a first Representation (Representation 1) 308a and a second Representation (Representation 2) 308b.

Within a Representation, the content may be divided in time into Segments. In one or more embodiments, a Segment includes a unit of data associated with a HTTP URL and may indicate a byte range to a resource identified in the MPD. A Segment may contain efficiently coded media data and metadata according to common media formats. In the particular embodiment illustrated in FIG. 3, first Representation (Representation 1) 308a includes a first Segment (Segment 1) 310a including timed metadata, such as ad-insertion data, associated with a particular point in time or duration in time of the media presentation timeline.

In one or more embodiments, ODE module 118 may translate the timed metadata within the MPD into representations appropriate for a particular client format suitable for one or more of client devices 114a-114c during streaming of a media presentation associated with the timed metadata. For example, in a particular embodiment the MPD may include an advertising Adaptation Set including one or more sparse tracks that are translated by ODE module 118 into one or more Microsoft Smooth sparse tracks before being sent to one or more of client devices 114a-114c. In one or more embodiments, the MPD includes an Adaptation Set that describes a time at which a sparse track segment occurs within a media presentation timeline and provides a URL to retrieve the timed metadata associated with the media presentation. The timed metadata is then used to populate the sparse track response to the client.

In a particular embodiment in which the Adaptation Set includes information associated with SCTE-35 timed metadata, the SCTE timed metadata may include markers that refer to a point in the stream in the future. Instead of indexing the location of the SCTE-35 marker, the MPD may be augmented to contain the location of an advertisement insertion in or out point within the media presentation timeline. In still other embodiments, other Adaptation Sets may be created for specific types of metadata. For example, an Adaptation Set may be created specifically to index a location of closed captioning data or subtitles within a media presentation.

In one or more embodiments, the Adaptation Sets in a DASH MPD are accompanied by DASH Segment Indexing (sidx) boxes. Where the MPD maps from a segment name to a timeline, the sidx box maps from a timeline to a byte range of the media content stored on storage device 110. A request for the segment is serviced by ODE module 118 using the MPD to locate the proper time range corresponding to the request and then uses the sidx boxes to locate the corresponding bytes of the media content stored on storage device 110. ODE module 118 may then apply a transformation to the timed metadata to convert from the common format timed metadata to a format of the timed metadata or sparse track data suitable for the particular client device 114a-114c. When ODE module 118 creates the sparse track or timed metadata, rather than searching the entire common format data segment for sparse track data or timed metadata, ODE module 118 consults the index or MPD to achieve a more efficient lookup of the sparse track data or timed metadata.

An example embodiment of an MPD Adaptation Set for advertisement timed metadata is described as follows:

```
<AdaptationSet
  mimeType=″video/mp2t ″
  codecs=″scte35″
  id=”scte35”>
  <BaseURL>scte35/</BaseURL>
  <SegmentTemplate timescale=″90000″
  media=″$Bandwidth$/$Time$.ts″>
      <SegmentTimeline>
      <S t=″0″ d=″2700000″ r=″0″ STCE35:breakID=″breakId″
```

| | |
|---|---|
| stce35:type=″in \| out″/ > | <!?30s ad at time 0 --> |

<S t=″900000″ d=″2700000″ r=″0″ STCE35:breakID=″breakId″

| | |
|---|---|
| stce35:type=″in\|out″/ /> | <!?30s ad at time 10 --> |

```
    </SegmentTimeline>
  </SegmentTemplate>
  <Representation id=″scte35-0 bandwidth=″250000″/>
  <Representation id=″scte35-1 bandwidth=″500000″/>
  <Representation id=″scte35-2 bandwidth=″1000000″/>
</AdaptationSet>
```

In the above example, <S t=“add start time” d=“ad duration” r=“0” scte35:breakId=“breakId” scte35:type=“in|out”/> are all pieces of timed metadata retrieved from the STCE35 TS packet by common format publisher module 116.

The mimeType attribute specifies a content type, specifically a MIME type, of the content stored within storage device 110. In the particular example illustrated, the MIME type is a video, mpeg2 transport stream. The codec attribute describes the type of media that is being indexed. In this particular example, the type of media that is being indexed are SCTE35 ad-insertion packets. packets. The ID attribute is a similar identifier specifying the type of media which in this case is STCE35 packets. The base URL attribute instructs ODE module 118 in the manner in which a URL for these specific STCE35 packets should be constructed.

The Segment Template timescale indicates the number of clock ticks per second, and the media template indicates the bandwidth for the bitrate stream which may take the bandwidth value further defined within the Adaptation Set which are indicated within timescale units. For example, at a time of one second, it would have a value of 90000. Each <S element describes a particular STCE35 event, whether it be a splice in or splice out or some other STCE35 event where <S t=“ad start time” indicates that start time of the event and d=“ad duration” indicates the duration of the event. SCTE35:breakID is a break identifier used to identify the particular STCE35 break and stce35:type=“in|out” is used to indicate whether the particular STCE35 break is a break in or a break out. A break out indicates the start of an advertisement insertion while a break in indicates the end of an advertisement insertion. In some embodiments, if the duration parameter is present on the break out, it is not necessary to include the “in” marker for a particular ad insertion instance. In a particular embodiment, the attributes in the Adaptation Set are all pieces of metadata extracted from a SCTE35 TS packet and placed into the MPD. When ODE module 118 reads the MPD to create a manifest for the target format, ODE module 118 can determine where to insert the advertisement in the media presentation timeline, the duration of the advertisement insertion and whether the advertisement insertion is a break in or a break out of an advertisement insertion. In the described example, ODE module 118 may determine that the first SCTE35 indicates that an advertisement is to be placed at time=0 for a duration of thirty seconds and that the advertisement is either a break in or a break out.

The Representation attribute specifies the different video bitrates represented by the “bandwidth” parameter and the corresponding different resolutions for the adaptive bit rate video during a timed metadata event. In the illustrated example, a first representation having an identifier of “stce35-0” and a bandwidth of 250000. Similarly a second representation having an identifier of “stce35-1” and a bandwidth of 500000, and a third representation having an identifier of “stce35-2” and a bandwidth of 1000000.

The particular Adaptation Set described in the above example includes the location of an Advertisement In/Out splice point (i.e. time 0 for 30 seconds), and a breakID attribute. In the case of Ad-Insertion, the breakID may be used directly by a ODE module 118 of origin server 108 from the MPD, rather than retrieving the SCTE35 packet to obtain the break ID.

In other embodiments, other new attributes may be added to the common format MPD as well. One such attribute may include a field defining a type of the Period of the MPD so that ODE module 118 can determine the reason for a new period such as due to a change in encoding parameters, stream loss, ad-insertion, or a playlist bookmark. Other attributes may be defined and included within the MPD manifest for use in manifest translation for items such as contents of a H.264 Advanced Video Coding (AVC) Sequence Parameter Set (SPS), a number of bits per audio sample, and/or a number of audio channels.

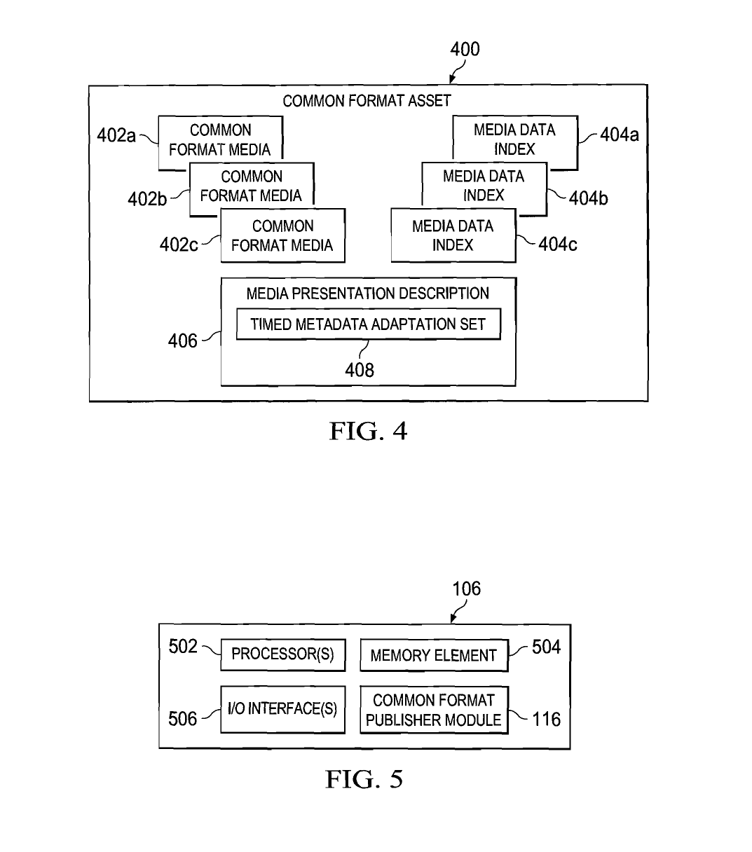

FIG. 4 is a simplified diagram of an embodiment of a common format asset 400 as generated by common format publisher 116 of encapsulator 106 of FIG. 1. In the particular embodiment of FIG. 4, common format asset 400 includes three common format media 402a-402c, three media data indexes 404a-404c, and a Media Presentation Description (MPD) 406. Common format media 402a-402c includes source media content portions received by encapsulator 106 from transcoder/encoder 104 that has been encapsulated and/or converted to a common format by common format publisher module 116. Media data indexes 404a-404c are indexes corresponding to common format media 402a-402c. MPD 406 is a manifest or file containing information about the common format media 402a-402c, such as one or more formats of segments of audio or video data that is used during presentation of the media content. The MPD 406 includes one or more timed metadata adaptation sets 408 including information extracted by common format publisher module 116 and inserted into MPD 406. In particular embodiments, adaptation set 408 includes timed metadata information indicative of a start time and a duration of a timed metadata event, such as an SCTE35 event as described herein. Although the particular embodiment is illustrated as using three common format media 402a-402c, three media data indexes 404a-404c, and a single MPD 406, it should be understood that in other embodiments common format asset 400 may include any number of common format media, media data indexes, and MPDs.

FIG. 5 illustrates a simplified block diagram of an embodiment of encapsulator 106 of FIG. 1. Encapsulator 106 includes processor(s) 502, memory element 504, input/output (I/O) interface(s) 506, and common format publisher 116. Processor(s) 502 is configured to execute various tasks of encapsulator 106 as described herein and memory element 504 is configured to store data associated with encapsulator 106. I/O interface(s) 506 is configured to receive communications from and send communications to other devices or software modules such as transcoder/encoder 104, timed metadata server 120, and origin server 108. Common format publisher 116 is configured to receive source video and/or source audio and timed metadata, convert the received source video and/or audio and timed metadata into a common media format asset and create one or more indexes of the source video and/or source audio and timed metadata as further described herein.

In one implementation, encapsulator 106 is a network element that includes software to achieve (or to foster) operations of encapsulator 106 as outlined herein in this Specification. Note that in one example, each of these elements can have an internal structure (e.g., a processor, a memory element, etc.) to facilitate some of the operations described herein. In other embodiments, these operations may be executed externally to this element, or included in some other network element to achieve this intended functionality. Alternatively, encapsulator 106 may include software (or reciprocating software) that can coordinate with other network elements in order to achieve the operations, as outlined herein. In still other embodiments, one or several devices may include any suitable algorithms, hardware, software, components, modules, interfaces, or objects that facilitate the operations thereof.

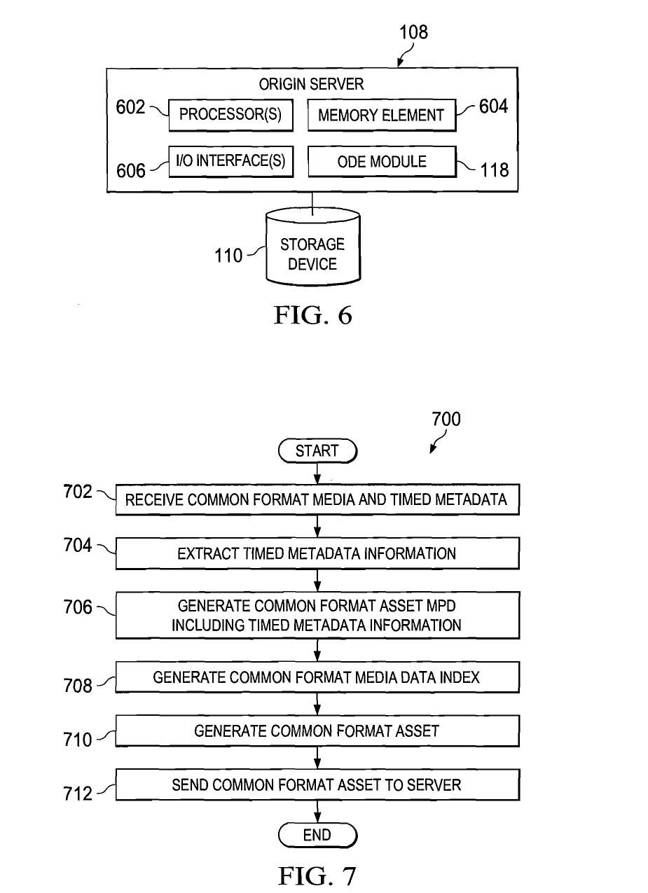

FIG. 6 illustrates a simplified block diagram of an embodiment of origin server 108 and storage device 110 of FIG. 1. Origin server 108 includes processor(s) 602, memory element 604, I/O interface(s) 606, and ODE module 118. As illustrated in FIG. 6, origin server 108 is further in communication with storage device 110. Processor(s) 602 is configured to execute various tasks of origin server 108 as described herein and memory element 604 is configured to store data associated with origin server 108. I/O interface(s) 606 is configured to receive communications from and send communications to other devices or software modules such as encapsulator 106, CDN 112, and client devices 114a-114c. ODE module 118 is configured to perform the various on-demand encapsulation operations as described herein.

In one implementation, origin server 108 is a network element that includes software to achieve (or to foster) the server and on-demand encapsulation operations as outlined herein in this Specification. Note that in one example, each of these elements can have an internal structure (e.g., a processor, a memory element, etc.) to facilitate some of the operations described herein. In other embodiments, these server and on-demand encapsulation operations may be executed externally to this element, or included in some other network element to achieve this intended functionality. Alternatively, origin server 108 may include software (or reciprocating software) that can coordinate with other network elements in order to achieve the operations, as outlined herein. In still other embodiments, one or several devices may include any suitable algorithms, hardware, software, components, modules, interfaces, or objects that facilitate the operations thereof.

FIG. 7 is a simplified flowchart 700 illustrating one potential operation of encapsulator 106 of FIG. 1. In 702, encapsulator 106 receives common format media that includes timed metadata. In at least one embodiment, the media includes data such as one or more of video data or audio data associated with a media presentation or program. In a particular embodiment, encapsulator 106 receives the common format media from transcoder/encoder 104, and transcoder/encoder 104 receives the media content from media content source 102. In 704, common format publisher 116 of encapsulator 106 extracts timed metadata information from the timed metadata. In various embodiments, the timed metadata information includes information regarding one or more timed metadata events including an indication of a source for timed metadata content related to the timed metadata event, an indication of a start time of the timed metadata event within a common timeline of the presentation of the media content, and an indication of a duration and/or end time of the timed metadata event. In a particular embodiment, the source indication may include a URL from which a video and/or audio advertisement to be inserted into the media presentation is to be obtained. In still another particular embodiment, the source indication may include an indication of a source for captions or subtitles related to the media presentation.

In 706, common format publisher module 106 generates a common format asset media presentation description (MPD) or other manifest including the timed metadata information. The common format asset MPD includes a manifest of the common format media content and other characteristics of the common format media content such as a description of one or more periods, one or more adaptation sets within a period, and one or more representations within an adaptation set. In one or more embodiments, the timed metadata information includes the source indication for the source of the timed metadata content related to the timed metadata event, the start time indication of the timed metadata event, an a duration indication or end time indication of the timed metadata event. In a particular embodiment, the timed metadata information is included within one or more adaptation sets of the common format asset MPD as described herein.

In 708, common format publisher module 106 generates a media data index corresponding to the common format media. In 710, common format publisher module 106 generates a common format asset including the common format media, the media data index, and the common format asset MPD. In 712, encapsulator 106 sends the common format asset to a server. In a particular embodiment, encapsulator 106 sends the common format asset to origin server 108 and origin server 108 stores the common format asset in one or more storage devices such as storage device 110. The flow then ends. As further discussed herein, in one or more embodiments ODE module 118 of origin server 108 may receive a request for timed metadata within the common format asset and ODE module 118 may extract the timed metadata information from the common format MPD and use the timed metadata information to determine how far back within the common format asset that it should go to retrieve a sufficient determined amount of the timed metadata necessary to produce the current timed metadata context at the current presentation time. For example, in a case in which the timed metadata is closed captioning data, the ODE module 110 may use the timed metadata index file to retrieve an amount of the caption data from the common format asset that is necessary to completely produce the current on-screen text for that instance in time and sends the caption data to client device 116.

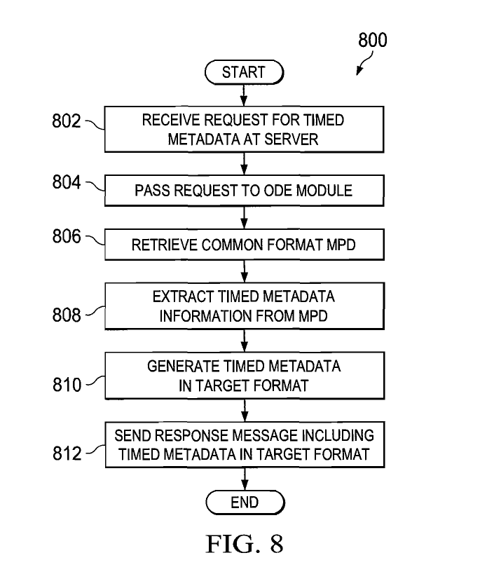

FIG. 8 is a simplified flowchart 800 illustrating one potential operation of origin server 108. In 802, origin server 108 receives a request for timed metadata from first client device 114a. In a particular embodiment, the requested timed metadata may include closed captioning, subtitles, ad-insertions or any other timed metadata associated with media content. In 804, origin server 108 passes the request to ODE module 118. In 806, ODE module 118 retrieves the common format MPD including the timed metadata information within the common format asset from storage device 112. In 808, ODE module 118 extracts the timed metadata information from the common format MPD within the common format asset. In a particular embodiment, the timed metadata information is extracted from at least one adaptation set within the common format MPD.

In 810, ODE module 118 generates timed metadata in a target format using the timed metadata information extracted from the common format MPD. In at least one embodiment, the target format for the timed metadata is a format suitable for first client device 114a. In a particular embodiment, the target format may be, for example, an HLS format, an HSS format, an HDS format or a DASH format in accordance with the capabilities of first client device 114a.

In 812, origin server 108 sends a response message including the timed metadata in the target format to first client device 114a. The flow then ends. In one or more embodiments, first client device 114a may then present the timed metadata in association with media content such as video or audio content.

Accordingly, in one or more embodiments, at least one adaptation sets is added to an MPD for each timed metadata track during encapsulation. In at least one embodiment, each adaptation set may include information indicating a timeline describing the start times and durations of content of the timed metadata track. In other embodiments, additional attributes may be added to other MPD elements to provide a more efficient index and reduce the need to scan through a large common format media assets in order to retrieve relatively small pieces of information.

Communication network 100 represents a series of points or nodes of interconnected communication paths for receiving and transmitting packets of information that propagate through communication system 100. Communication network 100 offers a communicative interface between sources and/or hosts, and may be any local area network (LAN), wireless local area network (WLAN), metropolitan area network (MAN), Intranet, Extranet, WAN, virtual private network (VPN), or any other appropriate architecture or system that facilitates communications in a network environment. Communication network 100 may implement a UDP/IP connection and use a TCP/IP communication language protocol in particular embodiments of the present disclosure. However, communication network 100 may alternatively implement any other suitable communication protocol for transmitting and receiving data packets within communication system 100.

Transcoder/encoder 104, encapsulator 106, and origin server 108 are network elements that facilitate on-demand encapsulating of timed metadata in a given network (e.g., for networks such as that illustrated in FIG. 1). As used herein in this Specification, the term ‘network element’ is meant to encompass routers, switches, gateways, bridges, loadbalancers, firewalls, inline service nodes, proxies, servers, processors, modules, or any other suitable device, component, element, proprietary appliance, or object operable to exchange information in a network environment. This network element may include any suitable hardware, software, components, modules, interfaces, or objects that facilitate the operations thereof. This may be inclusive of appropriate algorithms and communication protocols that allow for the effective exchange of data or information.

In one implementation, encapsulator 106 and origin server 108 include software to achieve (or to foster) the on-demand encapsulating of timed metadata operations, as outlined herein in this Specification. Note that in one example, each of these elements can have an internal structure (e.g., a processor, a memory element, etc.) to facilitate some of the operations described herein. In other embodiments, these on-demand encapsulating operations may be executed externally to these elements, or included in some other network element to achieve this intended functionality. Alternatively, encapsulator 106 and/or origin server 108 may include this software (or reciprocating software) that can coordinate with other network elements in order to achieve the operations, as outlined herein. In still other embodiments, one or several devices may include any suitable algorithms, hardware, software, components, modules, interfaces, or objects that facilitate the operations thereof.

Note that in certain example implementations, the on-demand encapsulation functions outlined herein may be implemented by logic encoded in one or more non-transitory, tangible media (e.g., embedded logic provided in an application specific integrated circuit (ASIC), digital signal processor (DSP) instructions, software (potentially inclusive of object code and source code) to be executed by a processor, or other similar machine, etc.). In some of these instances, a memory element (as shown in FIG. 5 and FIG. 6) can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor (as shown in FIG. 5 and/or FIG. 6) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

In one example implementation, encapsulator 106 and/or origin server 108 may include software in order to achieve the functions outlined herein. These activities can be facilitated by common format publisher module 116 and/or ODE module 118 (where these modules can be suitably combined in any appropriate manner, which may be based on particular configuration and/or provisioning needs). Encapsulator 106 and origin server 108 may include memory elements for storing information to be used in achieving the on-demand encapsulation activities, as discussed herein. Additionally, encapsulator 106 and/or origin server 108 may include a processor that can execute software or an algorithm to perform the on-demand encapsulation operations, as disclosed in this Specification. These devices may further keep information in any suitable memory element (random access memory (RAM), ROM, EPROM, EEPROM, ASIC, etc.), software, hardware, or in any other suitable component, device, element, or object where appropriate and based on particular needs. Any of the memory items discussed herein (e.g., database, tables, trees, cache, etc.) should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the example provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 100 (and its teachings) are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the steps in the preceding flow diagrams illustrate only some of the possible signaling scenarios and patterns that may be executed by, or within, communication system 100. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

It should also be noted that many of the previous discussions may imply a single client-server relationship. In reality, there is a multitude of servers and clients in certain implementations of the present disclosure. Moreover, the present disclosure can readily be extended to apply to intervening servers further upstream in the architecture. Any such permutations, scaling, and configurations are clearly within the broad scope of the present disclosure.

Although the present disclosure has been described in detail with reference to particular arrangements and configurations, these example configurations and arrangements may be changed significantly without departing from the scope of the present disclosure. Additionally, although communication system 100 has been illustrated with reference to particular elements and operations that facilitate the communication process, these elements and operations may be replaced by any suitable architecture or process that achieves the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving common format media including timed metadata associated with a timed metadata event;
extracting timed metadata information from the timed metadata, the timed metadata information including an indicator of a start time and an indicator of a duration of the timed metadata event;
generating a manifest corresponding to the common format media including the timed metadata information; and
generating a common format asset including the manifest.

2. The method of claim 1, further comprising sending the common format asset to at least one server.

3. The method of claim 1, further comprising:
receiving a request for the timed metadata from a particular client device;
extracting the timed metadata information from the manifest; and
generating the timed metadata in a target format suitable for the particular client device using the timed metadata information.

4. The method of claim 3, further comprising:
sending a response message including the timed metadata in the target format to the particular client device.

5. The method of claim 1, wherein the manifest is a media presentation description.

6. The method of claim 5, wherein the timed metadata information is included within an adaptation set of the media presentation description.

7. The method of claim 1, wherein the common format media is an MPEG2-TS adaptive transport stream file.

8. The method of claim 1, wherein the common format media is an ISO Base Media File Format (ISO-BMFF) file.

9. The method of claim 1, wherein the timed metadata includes at least one of caption data, subtitle data, ad-insertion marker data, a break identifier, and application-specific metadata.

10. One or more non-transitory tangible media that includes code for execution and when executed by a processor operable to perform operations comprising:
receiving common format media including timed metadata associated with a timed metadata event;
extracting timed metadata information from the timed metadata, the timed metadata information including an indicator of a start time and an indicator of a duration of the timed metadata event;
generating a manifest corresponding to the common format media including the timed metadata information; and
generating a common format asset including the manifest.

11. The media of claim 10, wherein the operations further comprise sending the common format asset to at least one server.

12. The media of claim 10, wherein the operations further comprise:
receiving a request for the timed metadata from a particular client device;
extracting the timed metadata information from the manifest; and
generating the timed metadata in a target format suitable for the particular client device using the timed metadata information.

13. The media of claim 12, wherein the operations further comprise sending a response message including the timed metadata in the target format to the particular client device.

14. The media of claim 10, wherein the manifest is a media presentation description.

15. The media of claim 14, wherein the timed metadata information is included within an adaptation set of the media presentation description.

16. The media of claim 10, wherein the timed metadata includes at least one of caption data, subtitle data, ad-insertion marker data, a break identifier, and application-specific metadata.

17. An apparatus, comprising:
a memory element configured to store data,
a processor operable to execute instructions associated with the data, and
at least one module being configured to:
receive common format media including timed metadata associated with a timed metadata event;
extract timed metadata information from the timed metadata, the timed metadata information including an indicator of a start time and an indicator of a duration of the timed metadata event;
generate a manifest corresponding to the common format media including the timed metadata information; and
generate a common format asset including the manifest.

18. The apparatus of claim 17, wherein the at least one module is further configured to send the common format media asset to at least one server.

19. The apparatus of claim 17, wherein the at least one module is further configured to:
receive a request for the timed metadata from a particular client device;
extract the timed metadata information from the manifest; and
generate the timed metadata in a target format suitable for the particular client device using the timed metadata information.

20. The apparatus of claim 19, wherein the at least one module is further configured to send a response message including the timed metadata in the target format to the particular client device.
